(19) United States
(12) Patent Application Publication
(10) Pub. No.: US 2006/0023114 A1
(43) Pub. Date: Feb. 2, 2006

(54) Camera apparatus and monitoring system

(75) Inventors: Takashi Shibuya, Kanagawa (JP); Hiroki Miura, Tokyo (JP); Hiroki Oka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/176,304

(22) Filed: Jul. 8, 2005

(30) Foreign Application Priority Data
Jul. 30, 2004 (JP) 2004-224353

(51) Int. Cl. H04N 5/225

(52) U.S. Cl. 348/373; 348/211.2

(57) ABSTRACT

A camera apparatus is disclosed, including a connector, an image capturing section, and a communication section. The connector is detachably fit to an elongated opening portion of a duct member in which a pair of elongated conductors are disposed along the elongated opening portion. The connector has a pair of terminals that are brought into contact with the pair of conductors. The image capturing section is held by the connector and captures an image of an object and obtains video data. The communication section is held by the connector and wirelessly transmits the video data obtained by the image capturing section. A power supply is connected to the pair of conductors of the duct member. When the connector is fit to the opening portion, the pair of terminals are brought into contact with the pair of conductors and power is supplied to the image capturing section and the communication section.

### CROSS REFERENCES TO RELATED APPLICATIONS

The present invention contains subject matter related to Japanese Patent Application No. 2004-224353 filed in the Japanese Patent Office on Jul. 30, 2004, the entire contents of which being incorporated herein by reference.

### BACKGROUND OF THE INVENTION

1. Field of the Invention

The present invention relates to a camera apparatus and a monitoring system.

2. Description of the Related Art

So far, monitoring systems have been used in various stores such as a convenience store, a department store, a bank, and various places such as an event site, a station, and a user's house to prevent crimes, manage facilities, and collect information. In a monitoring system that monitors the interior of a building, at least one camera device is installed on the ceilings and walls of the building. A host device that displays and/or records a monitored picture is disposed in an observation room or the like. The camera device and the host device are connected with cables.

The following patent document 1 describes a surveillance camera system that contains a camera operation unit, a video recorder, and a video monitor so that the surveillance camera system can be easily and quickly carried and installed. [Patent Document 1] Japanese Patent Laid-Open Publication No. HEI 5-300417

### SUMMARY OF THE INVENTION

However, in the related art, when camera devices are installed to prevent crimes, manage facilities, and collect information, the camera devices are directly mounted at places such as ceilings and walls with fasteners or the like or with dedicated stands. Moreover, power cables, video signal cables, and audio signal cables are connected to the camera devices (the audio cables are connected when the camera devices have microphones). The video signal cables and audio signal cables are connected to the host device.

Thus, it is not easy to install the camera devices used in the monitoring system of the related art. In addition, when the positions of the camera devices are changed, it is not easy to remove the camera devices from the installed places.

When the user employs a professional to install and remove the camera devices, he or she will work for them with an installation work cost and an installation work period.

In view of the foregoing, it would be desirable to provide a camera apparatus and a monitoring system that can be installed and removed quickly and easily without need to spend an installation work cost.

According to an embodiment of the present invention, there is provided a camera apparatus. The camera apparatus includes a connector, an image capturing section, and a communication section. The connector is capable of being detachably fit to an elongated opening portion of a duct member in which a pair of elongated conductors are disposed along the elongated opening portion. The connector has a pair of terminals that are brought into contact with the pair of conductors when the connector is fit to the elongated opening portion. The image capturing section is held by the connector. The image capturing section captures an image of an object and obtains video data. The communication section is held by the connector. The communication section wirelessly transmits the video data obtained by the image capturing section. A power supply is connected to the pair of conductors of the duct member. When the connector is fit to the opening portion, the pair of terminals are brought into contact with the pair of conductors and the power is supplied to the image capturing section and the communication section.

According to an embodiment of the present invention, there is provided a monitoring apparatus. The monitoring apparatus includes a camera device and a host device. The camera device includes a connector, an image capturing section, and a first communication section. The connector is capable of being detachably fit to an elongated opening portion of a duct member in which a pair of elongated conductors are disposed along the elongated opening portion. The connector has a pair of terminals that are brought into contact with the pair of conductors when the connector is fit to the elongated opening portion. The image capturing section is held by the connector. The image capturing section captures an image of an object and obtains video data. The first communication section is held by the connector. The first communication section wirelessly transmits the video data obtained by the image capturing section. A power supply is connected to the pair of conductors of the duct member. When the connector is fit to the opening portion, the pair of terminals are brought into contact with the pair of conductors and the power is supplied to the image capturing section and the first communication section. The host device includes a second communication section. The second communication section mutually communicates with the first communication section.

According to an embodiment of the present invention, an image of an object can be captured and video data can be obtained. The obtained video data can be wirelessly transmitted. A duct member has an elongated opening portion and elongated conductors. A connector has terminals. The connector is detachably fit to the opening portion of the duct member. When the connector is fit to the opening portion of the duct member, the terminals of the connector are brought into contact with the conductors of the duct member. As a result, power is supplied to the terminals. Thus, the camera device can be installed without cable connection work.

Thus, the camera device can be easily installed and removed without need to employ a professional. As a result, the camera device can be quickly installed and removed almost without an installation work period. In other words, a monitoring system can be quickly started. When a duct member has been installed, the camera device can be installed without need to spend an installation work period and an installation work cost. Even if a duct member is newly installed, this installation work cost is lower than the installation work cost for the duct member. Thus, the installation work cost can be reduced.

When the camera device is designed to have the shape of a light, the camera device can be used like a hidden camera.

These and other objects, features and advantages of the present invention will become more apparent in light of the following detailed description of a best mode embodiment-thereof, as illustrated in the accompanying drawings.

### BRIEF DESCRIPTION OF THE DRAWINGS

The invention will become more fully understood from the following detailed description, taken in conjunction with the accompanying drawings, wherein similar reference numerals denote similar elements, in which:

FIG. 1 is a schematic diagram describing a monitoring system according to an embodiment of the present invention;

FIG. 2 is an external perspective view showing an example of a lighting duct;

FIG. 3 is a detailed schematic diagram showing an example of the lighting duct;

FIG. 4 is an external perspective view showing an example of a plug;

FIG. 5 is a detailed schematic diagram showing the example of the plug;

FIG. 6 is a schematic diagram showing an example of an external structure of a camera device according to an embodiment of the present invention;

FIG. 7 is a block diagram showing an example of an internal structure of the camera device according to the embodiment of the present invention; and

FIG. 8 is a block diagram showing an example of a host device.

### DETAILED DESCRIPTION OF THE PREFERRED EMBODIMENTS

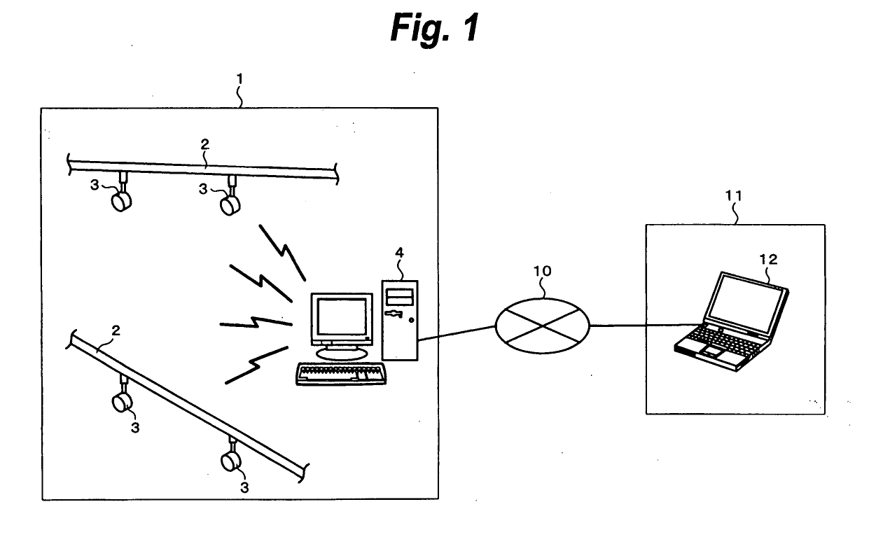

Next, with reference to the accompanying drawings, an embodiment of the present invention will be described. FIG. 1 is a schematic diagram describing a monitoring system according to an embodiment of the present invention. In the specification, “system” represents a logical congregation of a plurality of sections. In FIG. 1, reference numeral 1 represents a monitoring system according to the embodiment of the present invention. The monitoring system is installed in a store or the like. The monitoring system 1 is composed of a camera device 3 and a host device 4. The camera device 3 conforms to a lighting duct 2.

The lighting duct 2 is mainly used to increase the degree of freedom of the installation of indoor lighting. The lighting duct 2 is mainly installed in the ceiling or the like of the interior of a building. Since the lighting duct 2 allows the lighting position of the display of goods to be freely changed, it has been widely used in retail stores and so forth. A commercial power (for example, 100 V AC in Japan) can be supplied from the lighting duct 2. The lighting duct 2 can be one that conforms to Japan Industrial Standard (JIS) C8366.

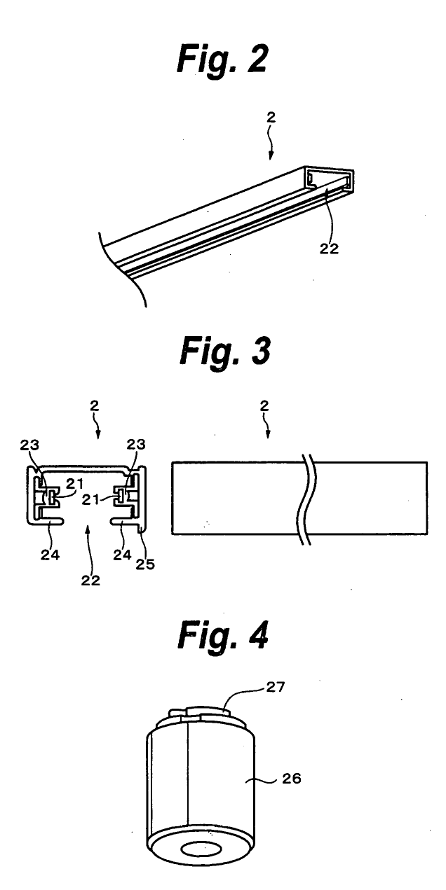

FIG. 2 and FIG. 3 show an example of the structure of the lighting duct 2. FIG. 2 is an external view of the lighting duct 2. FIG. 3 is a sectional view and a side view of the lighting duct 2. The lighting duct 2 has an elongated duct structure made of a metal or a synthetic resin. Disposed in the lighting duct 2 are a pair of conductors 21 that extend along the lighting duct 2. An opening portion 22 is formed along the lower surface of the lighting duct 2. As a result, the lighting duct 2 provides continuous plug outlets. The opening portion 22 may be formed continuously from end to end in the elongated direction of the lighting duct 2. Instead, the opening portion 22 may be intermittently formed from end to end in the elongated direction of the lighting duct 2.

The pair of conductors 21 are electrically connected to the hot side and the cold side of a commercial power through respective power connection members (not shown). The pair of conductors 21 are held with respective insulative holding members 23 disposed on both sides of the interior of the lighting duct 2. The opening portion 22 is formed between edge portions 24 that are formed on both ends in the elongated direction. The opening portion 22 is fit to a mounting portion of a plug. A protrusion 25 is formed on one of the edge portions 24 so that the plug can be mounted with correct polarities.

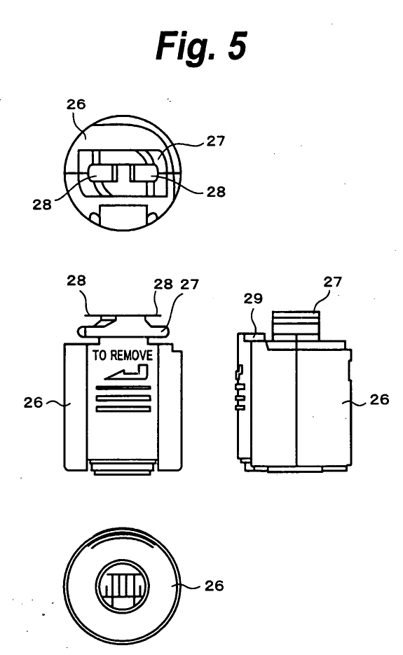

FIG. 4 and FIG. 5 show an example of the structure of the plug mounted to the lighting duct 2. FIG. 4 is an external view of the plug. FIG. 5 is a plan view of the plug. The plug 26 has a mounting portion 27 that is fit to the opening portion 22 of the lighting duct 2. The mounting portion 27 of the plug 26 is inserted into the opening portion 22 of the lighting duct 2 so that the elongated direction of the mounting portion 27 of the plug 26 matches the elongated direction of the opening portion 22 of the lighting duct 2. When the plug 26 is turned by for example 90 degrees while the mounting portion 27 is inserted into the opening portion 22, the plug 26 is locked to the lighting duct 2. Thus, the plug 26 can be easily mounted to the lighting duct 2 and dismounted therefrom.

When the mounting portion 27 of the plug 26 is fit to the opening portion 22 of the lighting duct 2, a pair of terminals 28 disposed in the mounting portion 27 are brought into contact with the pair of conductors 21 of the lighting duct 2. As a result, power is supplied from the lighting duct 2 to the plug 26. A protrusion 29 is formed on a main body portion of the plug 26 so that it is mounted to the lighting duct 2 with correct polarities. The protrusion 29 of the plug 26 and the protrusion 25 of the lighting duct 2 cause the pair of terminals 26 of the plug 26 to be connected to the lighting duct 2 with correct polarities. Thus, the plug 26 can be mounted to the lighting duct 2 in a predetermined direction.

The camera device 3 is at least one camera that is installed in a desired place. The camera device 3 is installed to prevent crimes, manage facilities, and collect information. A power reception portion of the camera device 3 has a structure that conforms to the structure of the lighting duct 2. In other words, the camera device 3 can be mounted to the lighting duct 2. When the camera device 3 is mounted to the lighting duct 2, power can be supplied from the lighting duct 2 to the camera device 3. Next, the camera device 3 that conforms to the lighting duct 2 mounted on for example a ceiling will be described.

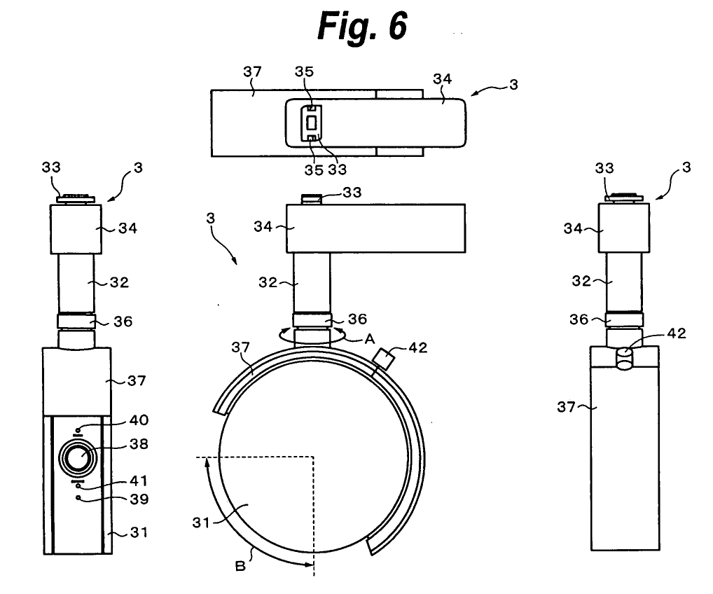

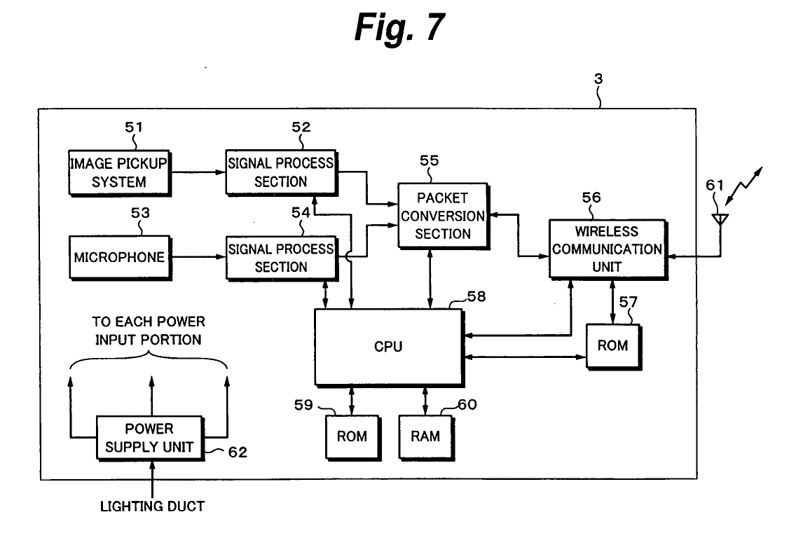

FIG. 6 shows an example of the external structure of the camera device 3. Disposed above a camera main body 31 of the camera device 3 is a cylindrical mounting stand 32. Disposed at one end of the mounting stand 32 are a connector 33 and a power supply adaptor 34.

The connector 33 has a mounting shape that conforms to the lighting duct 2. In other words, the connector 33 has the same shape as the mounting portion 27 of the plug 26. Thus, the connector 33 can be stably mounted to the lighting duct 2. In addition, the connector 33 has a pair of terminals 35 that have the same shape as the pair of terminals 28 disposed in the plug 26. Thus, when the connector 33 is mounted to the lighting duct 2, the pair of conductors 21 of the lighting duct 2 are brought into contact with the pair of terminal 35. As a result, power can be safely supplied from the lighting duct 2 to the camera device 3.

The connector 33 is mounted to the lighting duct 2 in the same manner as the plug 26 is. In other words, when the connector 33 is inserted into the opening portion 22 of the lighting duct 2 in the manner that the elongated direction of the connector 33 matches the elongated direction of the opening portion 22 of the lighting duct 2. When the connector 33 is turned by for example 90 degrees while the connector 33 is inserted into the opening portion 22, the connector 33 is locked to the lighting duct 2. As long as the connector 33 can be safely mounted to the lighting duct 2 and power can be safely supplied from the lighting duct 2 to the connector 33, the shape of the connector 33 is not limited.

The pair of terminals 35 are electrically connected to a power supply circuit in the camera main body 31 through the power supply adaptor 34 and the mounting stand 32 with electric wiring such as a power cable. Instead, the electric wiring, which connects the pair of terminals 35 and the power supply circuit, may be routed outside the mounting stand 32. The power supply adaptor 34 converts the power supplied from the lighting duct 2 into desired DC power. The power supply adaptor 34 has a protrusion (not shown) that has the same function as the protrusion 29 of the plug 26 has. In other words, the protrusion of the power supply adaptor 34 causes the pair of terminals 35 to be connected with correct polarities. Instead, the power supply adaptor 34 may be disposed in the mounting stand 32 or the camera main body 31. When the power supply adaptor 34 is disposed in the mounting stand 32 or the camera main body 31, the appearance of the camera device 3 is improved.

The camera main body 31 of the mounting stand 32 can be rotated by for example 360 degrees or more as denoted by arrow A. Thus, after the camera device 3 is installed to the lighting duct 2, the horizontal orientation of the camera main body 31 mounted to the mounting stand 32 can be freely changed. A rotation stopper 36 stops the horizontal rotation of the camera main body 31.

Connected to the rotation portion of the mounting stand 32 is the disc-shaped camera main body 31 through a camera cover 37. Disposed on the periphery of the camera main body 31 are a lens 38, a microphone hole 39, a power supply light emission portion 40, and a communication light emission portion 41. The positions of the lens 38, the microphone hole 39, the power supply light emission portion 40, and the communication light emission portion 41 are not limited. However, it is preferred that they be adjacently disposed.

The lens 38 is an imaging lens of the camera device 3. The microphone hole 39 allows the microphone disposed in the camera main body 31 to easily collect sound. The power supply light emission portion 40 is a light emission diode (LED) or the like that informs the user that the power of the camera device 3 is turned on. The communication light emission portion 41 is a light emission diode such as an LED that informs the user that the camera device 3 is communicating.

The camera main body 31 is mounted to the camera cover 37 so that the periphery of the camera main body 31 is vertically rotated and the lens 38 is moved by at least 90 degrees from the forward direction to the downward direction as denoted by arrow B shown in FIG. 6. Thus, after the camera device 3 is installed to the camera device 3, the vertical orientation of the camera main body 31 mounted on the mounting stand 32 can be freely changed in the range at least from the downward direction to the forward direction.

Thus, after the camera device 3 is installed to the lighting duct 2, the orientation of the camera main body 31 can be changed in the range at least from the downward direction to the forward direction. In other words, the image capturing direction can be changed. The range of the orientation of the camera main body 31 is not limited. Instead, the range of the vertical rotation of the camera main body 31 may be from the downward direction to the upward direction so that the orientation of the camera main body 31 can be changed in all directions.

The camera cover 37 has a shape that conforms to the periphery of the camera main body 31. Namely, the camera cover 37 partly covers the periphery of the camera main body 31 so that the camera cover 37 does not block the lens 38 when the camera main body 31 is vertically rotated. The camera cover 37 is secured to a rotation portion of the mounting stand 32. The camera cover 37 has a rotation stopper 42 that stops the vertical rotation of the camera main body 31.

FIG. 7 shown an example of the internal structure of the camera device 3. An image capturing system 51 is composed of an optical lens group that has an imaging lens, a solid image sensor as an image pickup device such as a charge coupled device (CCD), and so forth. The image capturing system 51 receives rays of light of an object and converts the rays of light into an analog image signal. The analog image signal converted by the image capturing system 51 is supplied to a signal process section 52.

The signal process section 52 performs a predetermined signal process for the analog image signal supplied from the image capturing system 51 and then converts the processed signal into digital video data. Thereafter, the signal process section 52 compression-encodes the digital video data according to a video compression system such as the Moving Picture Experts Group-4 (MPEG-4) system. The video data that have been compression-encoded by the signal process section 52 is supplied to a packet conversion section 55.

A microphone 53 converts sound into an analog audio signal. The analog audio signal converted by the microphone 53 is supplied to a signal process section 54. The signal process section 54 performs a predetermined signal process for the analog audio signal supplied from the microphone 53, converts the analog audio signal into digital audio data, and compression-encodes the digital audio data according to an audio compression system such as G.711, G.726, or G.721. The audio data that have been compression-encoded by the signal process section 54 are supplied to the packet conversion section 55.

The packet conversion section 55 multiplexes the video data supplied from the signal process section 52 and the audio data supplied from the signal process section 54, obtains a multiplexed stream, and packetizes the multiplexed stream in a predetermined packet size. The stream packetized by the packet conversion section 55 is supplied to a wireless communication unit 56.

The wireless communication unit 56 transmits the packetized stream supplied from the packet conversion section 55 according to a known wireless communication protocol such as IEEE 802.11b through an antenna 61 connected to the wireless communication unit 56. Connected to the wireless communication unit 56 is a light emission device such as an LED (not shown) that emits rays of light according to a communication state.

The camera device 3 has been assigned a unique address that is stored in for example a read-only memory (ROM) 57 of the camera device 3. The unique address identifies the camera device 3. The host device 4 manages the addresses of a plurality of camera devices 3 with for example a table. When the host device 4 requests a desired camera device 3 to transmit video data and audio data and transmit their packetized stream to the host device 4, the wireless communication unit 56 adds a header to the packetized stream and transmits the resultant stream to the host device 4.

Information such as a recipient address, a sender address, a serial number, and so forth is described in the header. The recipient address represents the address of the host device 4 that requests a camera device 3 to transmit a stream. The sender address represents the address of a camera device 3. The serial number represents a serial number with which a packetized stream is restored to an original stream.

In addition, the wireless communication unit 56 receives a packetized control signal according to a known wireless communication protocol such as IEEE 802.11 from the host device 4. The packetized control signal received by the wireless communication unit 56 is supplied to the packet conversion section 55.

The packet conversion section 55 extracts a control signal from the packetized control signal supplied from the wireless communication unit 56 and supplies the extracted control signal to a central processing unit (CPU) 58. The CPU 58 controls each section according to the control signal supplied from the packet conversion section 55. The CPU 58 controls the image capturing system 51 to perform a zoom operation and a color tone adjustment. In addition, the CPU 58 controls the power supply circuit to turn on/off the power supply.

The camera device 3 can manually change the image capturing direction. The image capturing direction may be changed by a motor that the CPU 58 controls according to for example the control signal supplied from the packet conversion section 55.

The CPU 58 is connected to each section that composes the camera device 3 and controls the entire camera device 3. The CPU 58 reads a program from a ROM 59. The CPU 58 executes various processes according to the program and issues commands. A random access memory (RAM) 60 is used as a work memory of the CPU 58.

A power supply unit 62 is a power conversion circuit that is built in the power supply adaptor 34. The power supply unit 62 converts the commercial power supplied from the lighting duct 2 into a DC power for the camera device 3. The power converted by the power supply unit 62 is supplied to power input potions of the signal process section 52, the signal process section 54, the packet conversion section 55, the wireless communication unit 56, the ROMs 57 and 58, the RAM 60, and the CPU 58 of the camera device 3. Light emission devices such as LEDs (not shown) are connected to the power conversion circuit and emit rays of light according to the power supply state.

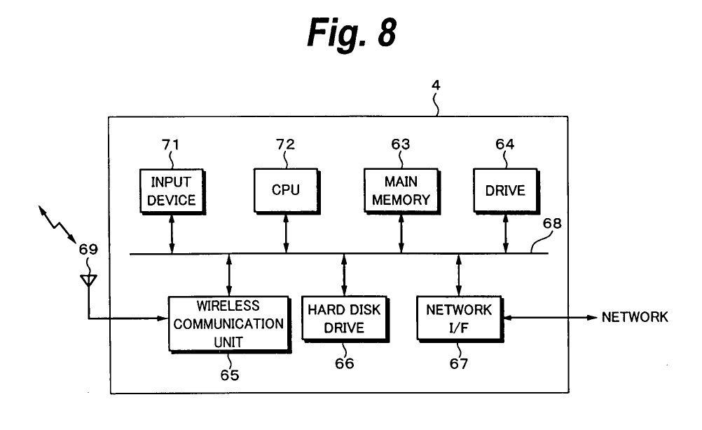

FIG. 8 is an example of the structure of the host device 4. The host device 4 can be composed of a general purpose computer device such as a personal computer. The host device 4 has for example an input device 71, a CPU 72, a main memory 63, a drive 64, a wireless communication unit 65, a hard disk drive 66, and a network interface (I/F) 67. These sections that compose the host device 4 are mutually connected through for example a bus 68.

The input device 71 is composed of devices such as a keyboard, a mouse, and so forth with which the user inputs data to the host device 4.

The CPU 72 controls the sections that compose the host device 4. These sections are the input device 71, the main memory 63, the drive 64, the wireless communication unit 65, the hard disk drive 66, and the network interface 67. In addition, the CPU 72 loads a program for example from the hard disk drive 66 to the main memory 63 and performs processes according to the loaded program.

The main memory 63 is a volatile storage device composed of a RAM or the like. The main memory 63 is used for a work area in which the CPU 72 executes the program.

The drive 64 is a device that reads data from a detachable recording medium such as a compact disc, a digital versatile disc (DVD), or a memory card. Thus, the host device 4 can read a program from the detachable recording medium such as a compact disc, a DVD, or a memory card and install the program. In addition, the host device 4 can download a program from a network through the network interface 67 and install the program.

The host device 4 can receive a packetized stream from the camera device 3 and perform for example a reproduction process and a storage process for the received stream.

The wireless communication unit 65 receives a packetized stream from the camera device 3 through an antenna 69 connected to the wireless communication unit 65 according to a known wireless communication protocol such as IEEE 802.11B.

When video data and audio data captured by the camera device 3 are stored, a packetized stream received by the wireless communication unit 65 is restored to an original stream according to header information described in the stream and stored in the hard disk drive 66. The hard disk drive 66 is a nonvolatile storage device. The hard disk drive 66 is used for storing for example a program file, a data file, and an address table of the camera device 3. The host device 4 can perform a reproduction process, an erase process, a copy process, a transfer process, and so forth for a stream stored in the hard disk drive 66.

When video data and audio data captured by the camera device 3 are output to output devices such as a display device and a speaker (not shown), a packetized stream received by the wireless communication unit 65 is restored to an original stream according to the header information described in the stream, converted into video and audio data suitable for the output devices, and output to the output devices such as a display device and a speaker.

In addition, the host device 4 can wirelessly control the camera device 3. When the host device 4 wirelessly controls the camera device 3, the wireless communication unit 65 transmits a packetized control signal generated under the control of the CPU 72 to the camera device 3 through the antenna 69 according to a known wireless communication protocol such as IEEE 802.11b.

The wireless communication unit 65 describes for example a header in a packetized control signal and transmits the resultant signal to the camera device 3. Information of a recipient address, a sender address, a serial number, and so forth is described in the header. The recipient address represents the address of a camera device 3 that the host device 4 controls. The wireless communication unit 65 has been assigned a unique address that is stored in for example a ROM (not shown). The sender address represents the address of the host device 4. The serial number represents a serial number with which the packetized stream is restored to the original stream.

The wireless communication unit 65 can transmit video data and audio data captured by the camera device 3 to a remote device 12 through the Internet. In this case, the packetized stream received by the wireless communication unit 65 is supplied to the network interface 67.

The network interface 67 is an interface connected to the Internet 10. The network interface 67 transmits a packetized stream supplied from the wireless communication unit 65 to the remote device 12 through the Internet.

A remote place 11 shown in FIG. 1 represents a place such as a store owner's house, which is away from for example a store in which the monitoring system 1 has been installed. The remote device 12 that is installed at the remote place 11 is a computer device such as a personal computer or a personal digital assistant (PDA) that can be connected to the Internet 10 and that has output devices such as a display device and a speaker or that can be connected to the output devices. The remote device 12 can be connected to the host device 4 through the Internet 10 and can remotely control the host device 4. In addition, the remote device 12 can wirelessly control the camera device 3 through the host device 4.

When there are a plurality of camera devices 3 and the remote device 12 has obtained their addresses, it can select a desired camera device 3 to receive video data and audio data therefrom. Thus, video data and audio data captured by a desired camera device 3 can be monitored at a place apart from the monitoring system 1 nearly in real time.

The remote device 12 can remotely operate the host device 4 through for example the Internet 10. Thus, the host device 4 can store a stream received by the wireless communication unit 65 to the hard disk drive 66, obtain a stream from the hard disk drive 66, and output the obtained stream to the output devices such as a display device and a speaker of the host device 4.

As described above, in the monitoring system 1 according to an embodiment of the present invention, the camera device 3 has a plug shape that can be mounted to the lighting duct 2, as long as the lighting duct 2 has been installed according to an internal structure such as the ceiling of a building, the camera device 3 can be easily installed by the user, not a professional.

Thus, only by mounting the camera device 3 to the lighting duct 2 (hanging the camera device 3 from the lighting duct 2 mounted on the ceiling), necessary power for the camera device 3 can be supplied from the lighting duct 2 to the camera device 3. As a result, power cable connection work is not necessary.

Since data are wirelessly exchanged between the camera device 3 and the host device 4 by the wireless modules disposed in the wireless communication unit 56 and wireless communication unit 65, video and audio signal cables and a control signal cable connected between the camera device 3 and the host device 4 can be omitted.

Thus, when the lighting duct 2 has been installed, the monitoring system 1 can be very easily installed without need to spend an installation work period and employ a professional. Thus, it is not necessary to close the store for the installation work period.

In addition, at any position of the opening portion 22 of the lighting duct 2, power can be supplied from the lighting duct 2 to the camera device 3. Since the camera main body 31 can be vertically and horizontally rotated, the degree of freedom of the installation of the camera device 3 can be increased.

According to the foregoing embodiment of the present invention, the monitoring system 1 is installed in a store. However, the monitoring system 1 can be installed in various places such as a bank, an event place, a station, and a user's house where the lighting duct 2 can be installed.

The shapes of the lighting duct 2 and the camera device 3 may be different from those of the foregoing embodiment of the present invention. Thus, the lighting duct 2 may be another duct that can be mounted according to an internal structure such as a ceiling or a wall of a building and that can supply power to the camera device 3 mounted to the duct. The connector 35 may have a shape that conforms to the duct member and can be easily detached therefrom. Instead, the camera device 3 may not be directly mounted to the lighting duct 2, but indirectly mounted thereto through an adaptor that conforms to the lighting duct 2.

The appearance and the internal structure of the camera device 3 are not limited to those of the foregoing embodiment. Instead, as long as the camera device 3 can be mounted to the lighting duct 2, power can be supplied from the lighting duct 2 to the camera device 3, and data can be wirelessly exchanged between the camera device 3 and the host device 4, another structure may be used. When the camera device 3 has the same appearance as a light that can be mounted to the lighting duct 2, video data and audio data captured by the camera device 3 can be monitored without sacrifice of the appearance of the camera device 3.

The Internet 10 may be another network such as a wide area network (WAN), a local area network (LAN), or the like. The remote device 12 may be a mobile terminal device such as a cellular phone.

It should be understood by those skilled in the art that various modifications, combinations, sub-combinations and alternations may occur depending on design requirements and other factors insofar as they are within the scope of the appended claims or the equivalents thereof.

What is claimed is:

1. A camera apparatus, comprising:
a connector that is capable of being detachably fit to an elongated opening portion of a duct member in which a pair of elongated conductors are disposed along the elongated opening portion, the connector having a pair of terminals that are brought into contact with the pair of conductors when the connector is fit to the elongated opening portion;
image capturing means, held by the connector, for capturing an image of an object and obtaining video data; and
communication means, held by the connector, for wirelessly transmitting the video data obtained by the image capturing means,
wherein a power supply is connected to the pair of conductors of the duct member, when the connector is fit to the opening portion, the pair of terminals are brought into contact with the pair of conductors and the power is supplied to the image capturing means and the communication means.

2. The camera apparatus as set forth in claim 1,
wherein the image capturing means is capable of changing the image capturing direction while the connector is fit to the opening portion.

3. The camera apparatus as set forth in claim 1,
wherein the camera device has a shape of a light.

4. The camera apparatus as set forth in claim 1, further comprising:
a microphone,
wherein audio data collected by the microphone are transmitted together with the video data by the communication means.

5. The camera apparatus as set forth in claim 1,
wherein the communication means wirelessly receives a control signal, and
wherein the camera device is operated according to the received control signal.

6. The camera apparatus as set forth in claim 1, further comprising:
a motor that changes the image capturing direction of the image capturing means,
wherein the motor is controlled with the control signal.

7. A monitoring apparatus, comprising:
a camera device including:
a connector that is capable of being detachably fit to an elongated opening portion of a duct member in which a pair of elongated conductors are disposed along the elongated opening portion, the connector having a pair of terminals that are brought into contact with the pair of conductors when the connector is fit to the elongated opening portion;
image capturing means, held by the connector, for capturing an image of an object and obtaining video data; and
first communication means, held by the connector, for wirelessly transmitting the video data obtained by the image capturing means,
wherein a power supply is connected to the pair of conductors of the duct member, when the connector is fit to the opening portion, the pair of terminals are brought into contact with the pair of conductors and the power is supplied to the image capturing means and the first communication means, and
a host device having:
second communication means for mutually communicating with the first communication means.

8. The monitoring system as set forth in claim 7,
wherein the image capturing means is capable of changing the image capturing direction while the connector is fit to the opening portion.

9. The monitoring system as set forth in claim 7,
wherein the camera device has a shape similar to a light.

10. The monitoring system as set forth in claim 7,
wherein the video data transmitted by the first communication means are received by the second communication means.

11. The monitoring system as set forth in claim 10,
wherein the camera device includes:
a microphone,
wherein audio data collected by the microphone are transmitted together with the video data by the first communication means, and
wherein the audio data transmitted by the first communication means are received together with the video data by the second communication means.

12. The monitoring system as set forth in claim 10,
wherein the host device stores the video data received by the second communication means to a storage device.

13. The monitoring system as set forth in claim 7,
wherein the second communication means transmits a control signal that causes the camera device to be controlled,
wherein the first communication means receives the control signal transmitted by the second communication means, and
wherein the camera device is controlled according to the control signal received by the first communication means.

14. The monitoring system as set forth in claim 13,
wherein the camera device includes:
a motor that changes the image capturing direction of the image capturing means,
wherein the motor is controlled with the control signal.

15. The monitoring system as set forth in claim 7,
wherein the host device is capable of being remotely controlled through a network.

16. A monitoring system, comprising:
a plurality of camera devices as set forth in claim 7, and
a host device having:
second communication means for mutually communicating with the first communication means.

17. A camera apparatus, comprising:
a connector that is capable of being detachably fit to an elongated opening portion of a duct member in which a pair of elongated conductors are disposed along the elongated opening portion, the connector having a pair of terminals that are brought into contact with the pair of conductors when the connector is fit to the elongated opening portion;
an image capturing section, held by the connector, capturing an image of an object and obtaining video data; and
a communication section, held by the connector, wirelessly transmitting the video data obtained by the image capturing section,
wherein a power supply is connected to the pair of conductors of the duct member, when the connector is fit to the opening portion, the pair of terminals are brought into contact with the pair of conductors and the power is supplied to the image capturing section and the communication section.

18. A monitoring apparatus, comprising:
a camera device including:
a connector that is capable of being detachably fit to an elongated opening portion of a duct member in which a pair of elongated conductors are disposed along the elongated opening portion, the connector having a pair of terminals that are brought into contact with the pair of conductors when the connector is fit to the elongated opening portion;
an image capturing section, held by the connector, capturing an image of an object and obtaining video data; and
a first communication section, held by the connector, wirelessly transmitting the video data obtained by the image capturing section,
wherein a power supply is connected to the pair of conductors of the duct member, when the connector is fit to the opening portion, the pair of terminals are brought into contact with the pair of conductors and the power is supplied to the image capturing section and the first communication section, and
a host device having:
a second communication section mutually communicating with the first communication section.
